(19) United States
(12) Patent Application Publication
(10) Pub. No.: US 2025/0346162 A1
(43) Pub. Date: Nov. 13, 2025

(54) VEHICLE SEAT

(71) Applicant: SUBARU CORPORATION, Tokyo (JP)

(72) Inventor: Isamu NAGASAWA, Tokyo (JP)

(73) Assignee: SUBARU CORPORATION, Tokyo (JP)

(21) Appl. No.: 19/177,015

(22) Filed: Apr. 11, 2025

(30) Foreign Application Priority Data
May 10, 2024 (JP) 2024-077553

(51) Int. Cl. B60N 2/427; B60N 2/16

(52) U.S. Cl. CPC B60N 2/427; B60N 2/161

(57) ABSTRACT

A vehicle seat includes: a seat cushion on which n occupant is to be seated; and a seat back that is configured to support a back of the occupant. The seat cushion includes: a seat surface that is configured to support a pelvis to thighs of the occupant; a seat surface frame that forms a frame of the seat cushion; a seat surface spring that is coupled to the seat surface frame on a vehicle front side and supports the seat surface; a lifter cross member that extends in a vehicle width direction on a vehicle rear side of the seat cushion and is configured to lift up and down the seat back and the seat cushion; and a spring cross member that is liftably provided on a vehicle lower side of the lifter cross member, extends in the vehicle width direction, and is coupled to the seat surface spring.

### CROSS-REFERENCE TO RELATED APPLICATIONS

The present application claims priority from Japanese Patent Application No. 2024-077553 filed on May 10, 2024, the entire contents of which are hereby incorporated by reference.

### BACKGROUND

The disclosure relates to a vehicle seat.

In recent years, for vehicles such as automobiles, self-driving control technologies that cause a vehicle to automatically travel with no need for a driving operation by a driver who is seated on a driver's seat of the vehicle have been advanced in order to reduce a burden of the driving operation of the driver and achieve improvement in safety.

In a vehicle equipped with such self-driving control technology, it is to be assumed that, not only on the passenger seat side but also on the driver's seat side, a driver assumes a comfortable posture by sliding a seating seat to the vehicle rear side and inclining a seat back to the vehicle rear side.

Vehicle seats in which the above-described comfortable position can be set includes a vehicle seat equipped with a lifter mechanism that can adjust the height of a seating position. Since frame members installed as such a lifter mechanism are configured to be inclinable and rotatable, the supporting strength of each frame member may be reduced.

### SUMMARY

An aspect of the disclosure provides a vehicle seat configured to be applied to a vehicle. The vehicle seat includes a seat cushion and a seat back. An occupant of the vehicle is to be seated on the seat cushion. The seat back is configured to support a back of the occupant. The seat cushion includes a seat surface, a seat surface frame, a seat surface spring, a lifter cross member, and a spring cross member. The seat surface is configured to support a pelvis to thighs of the occupant. The seat surface frame forms a frame of the seat cushion. The seat surface spring is coupled to the seat surface frame on a vehicle front side. The seat surface spring supports the seat surface. The lifter cross member extends in a vehicle width direction on a vehicle rear side of the seat cushion. The lifter cross member is configured to lift up and down the seat back and the seat cushion. The spring cross member is liftably provided on a vehicle lower side of the lifter cross member. The spring cross member extends in the vehicle width direction. The spring cross member is coupled to the seat surface spring.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic view illustrating a vehicle to which a vehicle seat according to an embodiment of the disclosure is applied.

FIGS. 2A to 2B are side views of the vehicle seat according to the embodiment of the disclosure as viewed from a vehicle width direction, where FIG. 2A illustrates a state in which the vehicle seat is at a high position, and FIG. 2B illustrates a state in which the vehicle seat is at a low position.

FIGS. 3A to 3B are perspective views of a seat lifter of the vehicle seat according to the embodiment of the disclosure with a seat surface removed as viewed from a vehicle upper front side, where 3A illustrates a state in which a lifter cross member and a spring cross member are at high positions, and FIG. 3B illustrates a state in which the lifter cross member is at a high position and the spring cross member is at a low position.

FIG. 4 is a cross-sectional view when a state in which a clutch of a drive unit in the vehicle seat according to the embodiment of the disclosure is disengaged is cross-sectioned in the side direction of the vehicle and viewed from the forward direction of the vehicle.

FIGS. 5A to 5B are side views, illustrating that the vehicle seat according to the embodiment of the disclosure is at the high position, as viewed from the vehicle width direction, where FIG. 5A illustrates a state in which a seat cushion is at a high position, and FIG. 5B illustrates a state in which the seat cushion is at a low position.

FIGS. 6A to 6B are cross-sectional views when a state of the clutch of the drive unit in the vehicle seat according to the embodiment of the disclosure is cross-sectioned in the side direction of the vehicle and viewed from the forward direction of the vehicle, where FIG. 6A illustrates a state in which a lifter clutch and a spring clutch are engaged with a drive clutch, and FIG. 6B illustrates a state in which the lifter clutch is engaged with the drive clutch and the spring clutch is disengaged from the drive clutch.

FIG. 7 is a side view of a vehicle seat according to an embodiment of the disclosure as viewed from the vehicle width direction.

FIG. 8 is a view illustrating a configuration of a determination unit in the vehicle seat according to the embodiment of the disclosure.

FIG. 9 is a flowchart illustrating the processing of the determination unit in the vehicle seat according to the embodiment of the disclosure.

FIG. 10 is a flowchart illustrating the processing of the determination unit when a collision of a vehicle occurs in the vehicle seat according to the embodiment of the disclosure.

### DETAILED DESCRIPTION

As a technique for solving the above-described problem, a technique for coupling frame members with a rod while securing the supporting strength of the frame members has been disclosed. In the technique, link members disposed separately from each other in a width direction serving as frame members supporting a seat cushion are coupled to each other with a rod.

For example, each of the link members has a stepped shape that changes a separation distance between the link members. The stepped shape defines an end portion contact surface that comes in surface contact with an end portion surface of the rod and an outer circumference contact surface that comes in surface contact with an outer circumferential surface of the rod. These link members are joined with the rod and coupled in a state in which the end portion contact surfaces and the outer circumference contact surfaces are in surface contact with the end portion surfaces and the outer circumferential surface of the rod, respectively (for example, see Japanese Patent (JP) No. 4978282).

The technique disclosed in JP No. 4978282 is a technique capable of coupling the link members that liftably link-couple a seat cushion in a lifter mechanism by a rod while securing the supporting strength of each frame member.

However, in the technique disclosed in JP No. 4978282, the posture of an occupant in a comfortable position in which a seat back is inclined rearward and a load on the occupant when a collision of a vehicle occurs may not be considered.

The disclosure has been made in view of the above-described problem, and an object thereof is to provide a vehicle seat that allows an occupant to take a posture for safely taking a rest and reduces a load on the occupant when a collision of a vehicle occurs.

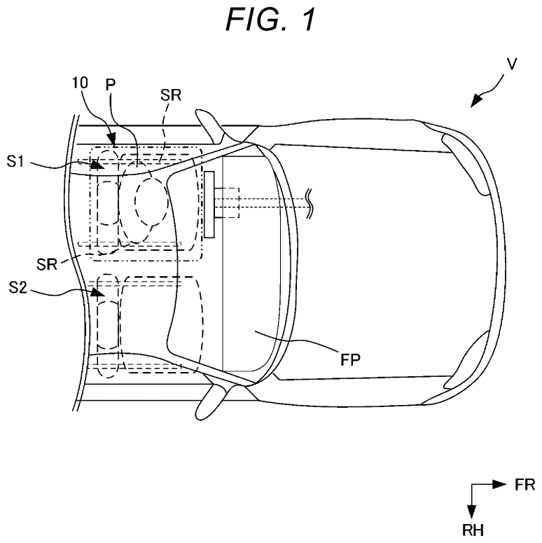

A vehicle seat 10 and a vehicle seat 10A according to embodiments will be described with reference to FIG. 1 to FIG. 10. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration denoted with the same numerals to avoid any redundant description.

It is noted that a vehicle V is described as an electric vehicle (EV) using a vehicle drive motor as a drive source for example, but may be a hybrid electric vehicle (HEV) including multiple drive sources of an engine and a power unit, or may be an internal combustion vehicle including an internal combustion engine. An arrow FR indicated as appropriate in the drawings is the vehicle travel direction of the vehicle V illustrated in FIG. 1, an arrow UP indicates an upper side of the vehicle V, and an arrow RH indicates the right side in the vehicle travel direction. Unless otherwise specified, an up-down direction, a front-rear direction, and a left-right direction used in the following description mean the up-down direction in the vehicle travel direction, the front-rear direction with the vehicle travel direction as the front side, and the left-right direction in the vehicle travel direction, respectively.

In the embodiment, a case in which a seating seat S1 as a driver's seat is provided on the left side in the vehicle travel direction in the vehicle V and the vehicle seat 10 is provided at the seating seat S1 will be described. The driver's seat may be present on the left side or the right side in the vehicle V in the vehicle travel direction. The vehicle seat 10 may be provided at a passenger seat S2 or may be provided at a rear seat.

### First Embodiment

The vehicle seat 10 according to the present embodiment will be described with reference to FIGS. 1 to 7.

### Vehicle Seat 10

As illustrated in FIG. 1, the vehicle V includes, on the vehicle rear side of a front panel FP, the seating seat S1 as a driver's seat on which an occupant P is seated and the passenger seat S2. The vehicle seat 10 includes the seating seat S1 and a slide rail SR.

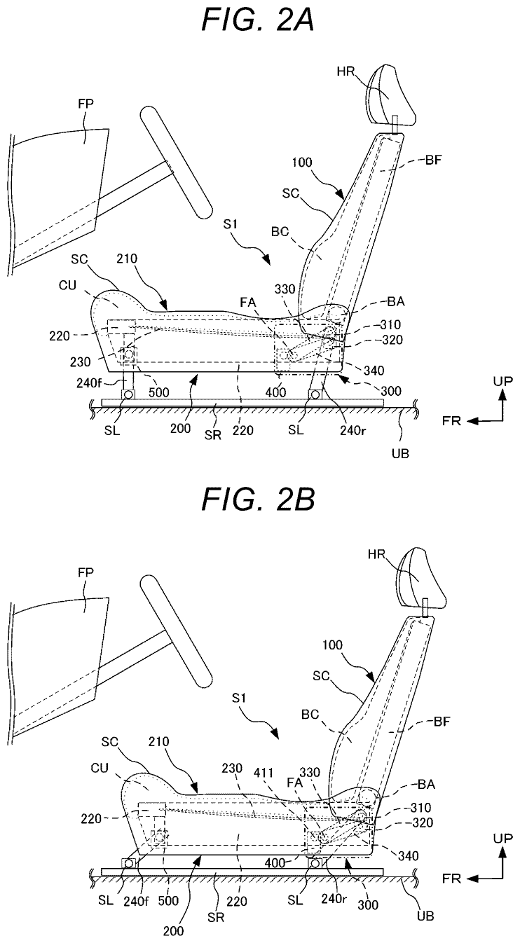

As illustrated in FIGS. 2A to 2B, the seating seat S1 includes a seat back 100, a seat cushion 200, a seat lifter 300, and a headrest HR. The seating seat S1 is movably fixed to a vehicle floor via the slide rail SR provided on the vehicle lower side of the seat cushion 200. The slide rail SR is fixed to a floor panel UB of the vehicle V and extends in the vehicle front-rear direction. A slide leg SL is provided at the slide rail SR so as to be movable in the vehicle front-rear direction.

### Seat Back 100

The seat back 100 supports the back of the occupant P. The seat back 100 is disposed on the vehicle rear side of the seating seat S1 in a state of rising in the vehicle up-down direction. The seat back 100 is provided such that the angle thereof can be adjusted in the vehicle front-rear direction around a rotary shaft BA provided on the vehicle lower side.

The outer surface of the seat back 100 is covered with a seat cover SC made of a member such as fabric or leather. The seat cover SC includes therein a seat back cushion BC and a seat back frame BF.

### Seat Cushion 200

The seat cushion 200 supports the pelvis to the thighs of the occupant P seated.

The seat cushion 200 includes a seat surface 210, a seat surface frame 220, a seat surface spring 230, and a seat leg 240 (a seat leg 240f and a seat leg 240r).

### Seat Surface 210

The surface of the seat surface 210 is covered with the seat cover SC made of a member such as fabric. A cushion urethane CU is provided on the vehicle lower side of the seat cover SC. The seat surface spring 230 is provided on the vehicle lower side of the seat surface 210, and the seat surface spring 230 supports the seat surface 210.

### Seat Surface Frame 220

The seat surface frame 220 forms a frame of the seat cushion 200 and is provided on the vehicle lower side of the seat surface 210. The seat surface frame 220 is provided to surround the seat surface 210 with a member such as metal in a substantially rectangular frame shape as viewed from the vehicle upper side. One end of the seat surface spring 230 is fixed to the vehicle front side of the seat surface frame 220.

Each of the outer sides of the seat surface frame 220 in a vehicle width direction has a substantially elongated plate shape extending in the vehicle front-rear direction with the vehicle width direction as a plate thickness direction. The vehicle rear side of the seat surface frame 220 is placed on the vehicle upper side of a lifter cross member 310 extending in the vehicle width direction to be described below.

The seat back 100 is coupled to the vehicle rear side of the seat surface frame 220 via the rotary shaft BA such that the angle of the seat back 100 can be adjusted. A drive unit 400, which will be described below, is disposed on the outer side of the seat surface frame 220 in the vehicle width direction.

The slide rail SR, which movably fixes the seating seat S1 to the vehicle floor, is provided on the vehicle lower side of the seat surface frame 220. The slide rail SR is made of a member such as metal in a U shape opening on the vehicle upper side. The seat leg 240 is engaged with the slide rail SR via the slide leg SL so as to be movable in the vehicle front-rear direction.

### Seat Surface Spring 230

The seat surface spring 230 is coupled to the seat surface frame 220 on the vehicle front side to support the seat surface 210. The seat surface spring 230 extends in the vehicle front-rear direction on the vehicle lower side of the seat surface 210. The seat surface spring 230 is an S-shaped spring made of metal or the like having a spring property. Multiple seat surface springs 230 (six in the embodiment) span across the vehicle front side of the seat surface frame 220 and a spring cross member 320.

The end portion of the seat surface spring 230 on the vehicle front side is coupled to the seat surface frame 220 and the end portion of the seat surface spring 230 on the vehicle rear side is coupled to the spring cross member 320.

### Seat Leg 240

The seat leg 240 includes the seat leg 240f provided on both sides of the vehicle front side and the seat leg 240r provided on both sides of the vehicle rear side. The seat leg 240 is made of a member such as metal in a substantially rectangular closed cross-sectional shape having long sides in the vehicle up-down direction. A through hole having a substantially circular shape, through which a rotary shaft is inserted, is provided at the vehicle upper side and the vehicle lower side of the seat leg 240.

The vehicle upper side of the seat leg 240f is rotatably engaged with the seat surface frame 220 and a front lifter 500 to be described below. The vehicle lower side of the seat leg 240f is rotatably engaged with the slide leg SL provided at the slide rail SR.

The vehicle upper side of the seat leg 240r is rotatably engaged with the lifter cross member 310, a lifter rod 330, and the drive unit 400. The vehicle lower side of the seat leg 240r is rotatably engaged with the slide leg SL.

### Seat Lifter 300

The seat lifter 300 lifts up and down the seat back 100 and the seat cushion 200. The seat lifter 300 includes the lifter cross member 310, the spring cross member 320, the lifter rod 330, a spring rod 340, and the drive unit 400. The front lifter 500, which lifts up and down the vehicle front side of the seat cushion 200, is provided on the vehicle front side of the seat cushion 200.

### Lifter Cross Member 310

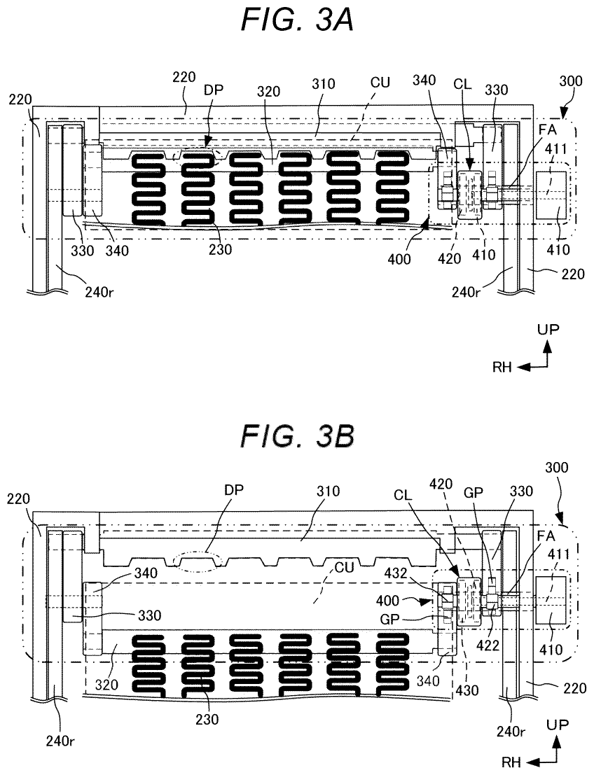

The lifter cross member 310 extends in the vehicle width direction on the vehicle rear side of the seat cushion 200 and lifts up and down the seat back 100 and the seat cushion 200. The lifter cross member 310 is made of a member having high rigidity such as metal in a substantially rectangular closed cross-sectional shape. The lifter cross member 310 is disposed on the vehicle rear side of the seat cushion 200. The seat surface frame 220 is placed on the vehicle upper side of the lifter cross member 310 as illustrated in FIGS. 3A to 3B.

The lifter rod 330 and the seat leg 240r are rotatably coupled to both sides of the lifter cross member 310 in the vehicle width direction. The lifter cross member 310 is provided with a depression DP for avoiding interference with the seat surface spring 230 coupled to the spring cross member 320.

### Spring Cross Member 320

The spring cross member 320 is liftably provided on the vehicle lower side of the lifter cross member 310 and extends in the vehicle width direction, and the seat surface spring 230 is coupled to the vehicle upper side of the spring cross member 320.

The spring cross member 320 is made of, for example, a member having high rigidity such as metal in a substantially rectangular closed cross-sectional shape. The spring cross member 320 is disposed on the vehicle rear side of the seat cushion 200.

Each side end of the spring cross member 320 in the vehicle width direction is rotatably coupled to the spring rod 340.

### Lifter Rod 330

The lifter rod 330 is made of a member having high rigidity such as metal in a substantially rectangular shape having a plate thickness in the vehicle width direction and having long sides in the vehicle front-rear direction. As illustrated in FIGS. 2A to 2B, the vehicle rear side of the lifter rod 330 is rotatably engaged with the outer side of the lifter cross member 310 in the vehicle width direction. The vehicle front side in the lifter rod 330 is penetrated through and fixed by a rod fixing shaft FA. The outer end portions of the rod fixing shaft FA in the vehicle width direction are rotatably engaged with the seat surface frame 220.

As illustrated in FIGS. 3A to 3B, a gear plate GP, which is engaged with a lifter clutch gear 422 provided at a lifter clutch shaft 421, is provided on the vehicle front side of the lifter rod 330.

### Spring Rod 340

The spring rod 340 is made of a member having high rigidity such as metal in a substantially rectangular shape having a plate thickness in the vehicle width direction and having long sides in the vehicle front-rear direction. As illustrated in FIGS. 2A to 2B, the vehicle rear side of the spring rod 340 is rotatably engaged with both sides of the spring cross member 320 in the vehicle width direction. The vehicle front side in the spring rod 340 is rotatably engaged with the inner end portion of the rod fixing shaft FA in the vehicle width direction. The outer end portion of the rod fixing shaft FA in the vehicle width direction is fixed to the seat surface frame 220.

As illustrated in FIGS. 3A to 3B, the gear plate GP, which is engaged with a spring clutch gear 432 provided at a spring clutch shaft 431, is provided on the vehicle front side of the spring rod 340.

### Drive Unit 400

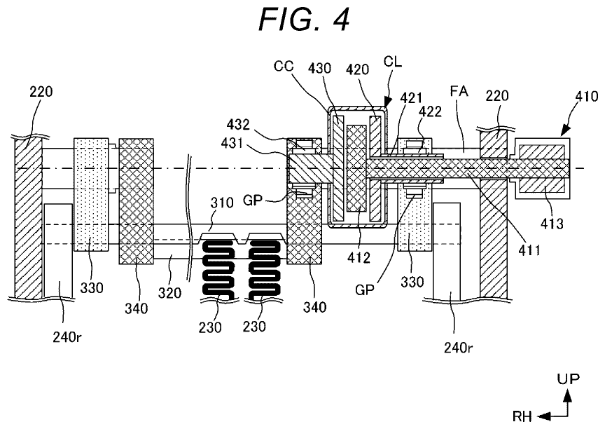

The drive unit 400 lifts up and down the lifter cross member 310 and the spring cross member 320. As illustrated in FIG. 4, the drive unit 400 includes a lifter motor 410 and a drive clutch CL. The drive clutch CL is provided with a lifter clutch 420 as a first clutch that moves the lifter cross member 310 and a spring clutch 430 as a second clutch that moves the spring cross member 320.

### Lifter Motor 410

The lifter motor 410 includes a drive shaft 411, a drive clutch 412, and a motor 413. The drive clutch 412 and the motor 413 are coupled to the drive shaft 411.

The drive shaft 411, the lifter clutch shaft 421, and the spring clutch shaft 431 are coaxially provided. The drive shaft 411 is disposed, for example, so as to penetrate through the inside of the lifter clutch shaft 421.

The drive clutch 412 is provided inside the drive clutch CL. The drive shaft 411 penetrates through the seat surface frame 220 and is coupled to the drive clutch 412. The lifter motor 410 is fixed to the outer side of the seat surface frame 220 in the vehicle width direction.

### Drive Clutch CL

The drive clutch CL transmits a drive force from the lifter motor 410 to the seat lifter 300. The drive clutch CL is provided with a clutch case CC, and the drive clutch 412, the lifter clutch 420, and the spring clutch 430 are provided inside the clutch case CC.

### Lifter Clutch 420

The lifter clutch 420 moves the lifter cross member 310 via the lifter rod 330. The lifter clutch 420 is a clutch plate made of a member mixed with metal or the like in a substantially disk shape having a plate thickness in the vehicle width direction. The lifter clutch shaft 421 is fixed to the lifter clutch 420 toward the outer side in the vehicle width direction.

The lifter clutch shaft 421 is a rotary shaft for the lifter clutch 420. The lifter clutch shaft 421 extends toward the outer side in the vehicle width direction. The lifter clutch shaft 421 is, for example, a pipe rod made of a member such as metal in a hollow cylindrical shape. The spring clutch shaft 431 rotatably penetrates the inside of the lifter clutch shaft 421 in the vehicle width direction. The lifter clutch gear 422, which is engaged with the gear plate GP provided at the lifter rod 330, is fixed to the lifter clutch shaft 421.

### Spring Clutch 430

The spring clutch 430 moves the spring cross member 320 via the spring rod 340. The spring clutch 430 is a clutch plate made of a member mixed with metal or the like in a substantially disk shape having a plate thickness in the vehicle width direction. The spring clutch shaft 431 is fixed to the spring clutch 430 toward the inner side in the vehicle width direction.

The spring clutch shaft 431 is a rotary shaft for the spring clutch 430. The spring clutch shaft 431 extends toward the inner side in the vehicle width direction. The spring clutch shaft 431 is, for example, a rod made of a member such as metal in a substantially cylindrical shape. The spring clutch gear 432, which is engaged with the gear plate GP provided at the spring rod 340, is fixed to the spring clutch shaft 431.

### Front Lifter 500

The front lifter 500 is disposed on a vehicle lower front side of the seat surface frame 220. The front lifter 500 is engaged with a gear (not illustrated) of the seat leg 240f. The front lifter 500 moves, in conjunction with the drive unit 400, the vehicle upper side end portion of the seat leg 240f in the vehicle front-rear direction, thereby lifting up and down the vehicle front side of the seat surface frame 220 in the seat cushion 200.

### Effects

The effects in the vehicle seat 10 according to the embodiment configured as above will be described with reference to FIGS. 2A to 2B and FIGS. 5A to 6B.

### Lifting Vehicle Seat 10 Up and Down

In order to change the position of the vehicle seat 10 from a low position illustrated in FIG. 2B to a high position illustrated in FIG. 2A, for example, the occupant P performs an operation of lifting up the vehicle seat 10 such as pressing a seat lift-up button to cause the lifter motor 410 in the drive unit 400 to start rotating.

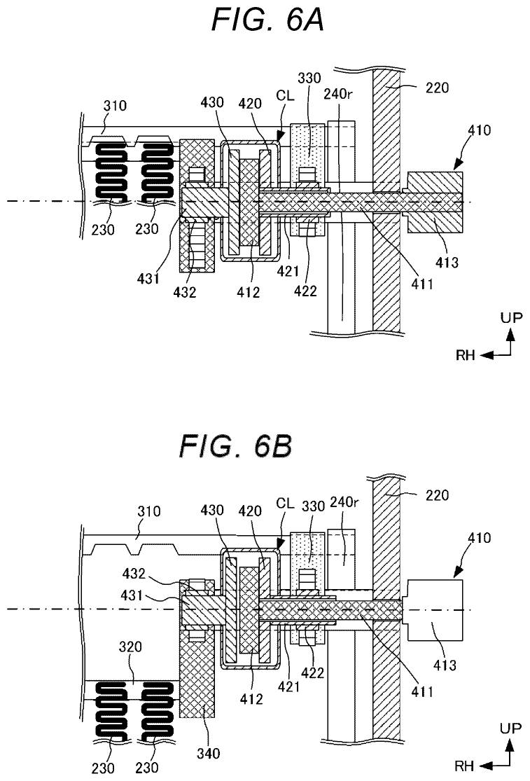

The lifter clutch 420 and the spring clutch 430 move in a direction allowing the engagement with the drive clutch 412 as illustrated in FIG. 6A, whereby the rotation of the lifter motor 410 is transmitted to the lifter clutch shaft 421 and the spring clutch shaft 431. The rotation of the lifter clutch shaft 421 and the spring clutch shaft 431 is transmitted to the lifter rod 330 and the spring rod 340 via the lifter clutch gear 422 and the spring clutch gear 432. The vehicle rear side end portions of the lifter rod 330 and the spring rod 340 are lifted toward the vehicle upper side. The seat leg 240r engaged with the vehicle rear side end portion of the lifter rod 330 rises toward a vehicle upper front side as the lifter rod 330 is lifted up toward the vehicle upper side.

Then, both the lifter cross member 310 and the spring cross member 320 engaged with the vehicle rear side end portions of the lifter rod 330 and the spring rod 340 are lifted up toward the vehicle upper side. The seat surface frame 220 placed on the vehicle rear side of the lifter rod 330 is lifted up toward the vehicle upper front side. Further, the seat surface spring 230 coupled to the vehicle rear side of the spring rod 340 is lifted up toward the vehicle upper front side together with the seat surface frame 220.

At this time, since the depression DP is provided at the lifter cross member 310, the lifter cross member 310 does not interfere with the seat surface spring 230. Thus, the spring cross member 320 lifts up and down the seat surface 210, which is supported from the vehicle lower side the seat surface spring 230, without causing uncomfortable feeling.

On the vehicle front side of the seat surface frame 220, the front lifter 500 lifts up the vehicle front side of the seat surface frame 220 toward the vehicle upper front side in conjunction with the drive unit 400.

In this way, the seat surface frame 220 and the seat surface spring 230 are lifted up toward the vehicle upper side, whereby the position of the seating seat S1 is changed from the low position illustrated in FIG. 2B to the high position illustrated in FIG. 2A.

When the position of the seating seat S1 is changed from the high position to the low position, the rotation of the lifter motor 410 is reversed in a state in which the lifter clutch 420 and the spring clutch 430 are engaged with the drive clutch 412.

### Changing Vehicle Seat 10 to Rest Position Setting

In setting the vehicle seat 10 to a rest position in which the occupant P takes a resting posture, for example, the position of the pelvis of the occupant P is fixed and the spine of the occupant P is stretched into an S shape.

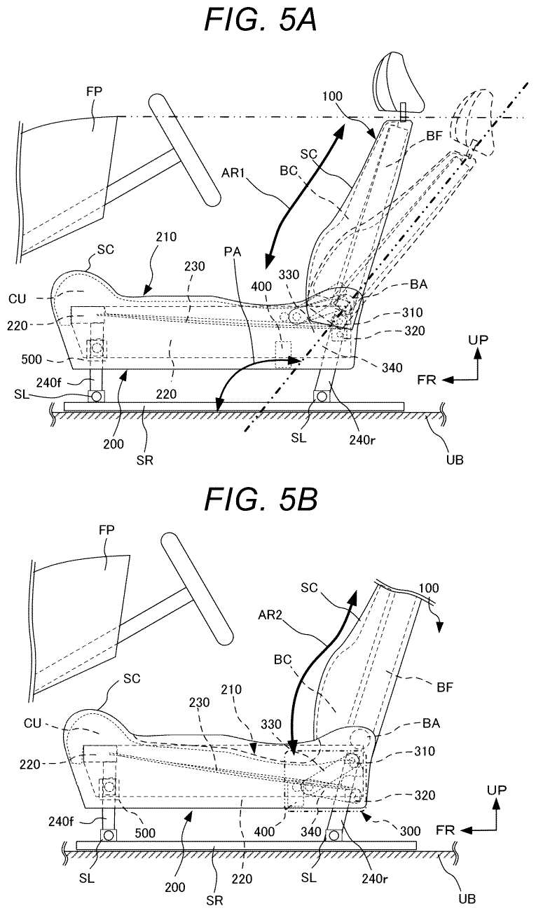

The rest position setting of the vehicle seat 10 in which the occupant P takes a resting posture corresponds to a setting in which the seat surface 210 is at a low position as illustrated in FIG. 5B. Here, an arrow AR1 in FIG. 5A and an arrow AR2 in FIG. 5B represent the curves of the spine of the occupant P seated on the seating seat S1.

As illustrated in FIG. 5A, in a drive position setting in which the seat surface 210 is at a high position and the seat back 100 is inclined forward from a predetermined angle PA, the curve of the spine of the occupant P gets close to a straight line toward the vehicle lower side. The predetermined angle PA of the seat back 100 is, for example, an angle at which the position of the center of the headrest HR in the vehicle up-down direction is at the same height as the front panel FP.

As illustrated in FIG. 5B, in the rest position setting in which the seat surface 210 is at the low position, the spine of the occupant P curves also on the vehicle lower side and thus the curve of the spine becomes an S shape. Further, the seat surface 210 is brought to a position lower than both sides of the seat cushion 200 in the vehicle width direction, so that the position of the pelvis is fixed. Then, the vehicle seat 10 causes the posture of the occupant P to be a back stretched state, so that the posture of the occupant P becomes a resting posture.

In addition to the rest position setting, by establishing a comfortable position setting in which the seat back 100 is inclined rearward to or in excess of the predetermined angle PA, the posture of the occupant P becomes a napping posture.

When the seat surface 210 is moved to the low position as illustrated in FIG. 5B, the lifter clutch 420 is engaged with the drive clutch 412 as illustrated in FIG. 6B. The spring clutch 430 gradually releases the engagement with the drive clutch 412 to lift down the spring rod 340 toward the vehicle lower side, thereby gently lifting down the spring cross member 320. Then, the seat surface 210 is lifted down together with the seat surface spring 230, so that the seat surface 210 gently changes to a state of being located at the low position.

### Collision of Vehicle V

When a collision of the vehicle V occurs, the vehicle seat 10 changes the position of the seat surface 210 via the drive unit 400.

For example, when a collision of the vehicle V occurs, the vehicle seat 10 immediately changes the position of the seat surface 210 from the high position illustrated in FIG. 5A to the low position illustrated in FIG. 5B via the drive unit 400.

At this time, the lifter clutch 420 is engaged with the drive clutch 412 as illustrated in FIG. 6B. The spring clutch 430 immediately releases the engagement with the drive clutch 412 to lift down the spring rod 340 toward the vehicle lower side, thereby lifting down the spring cross member 320. Then, the seat surface 210 is lifted down together with the seat surface spring 230, so that the seat surface 210 immediately changes to a state of being located at the low position. The seat surface 210 is brought to a position lower than both sides of the seat cushion 200 in the vehicle width direction, so that the position of the pelvis of the occupant P is fixed.

In this way, when a collision of the vehicle V occurs, the pelvis of the occupant P is fixed, whereby the occupant P is prevented from sliding toward the vehicle upper side along the seat back 100 and a load on the occupant P due to the impact at the collision is reduced.

As described above, the vehicle seat 10 according to the embodiment is the vehicle seat 10 provided with the seat cushion 200 on which the occupant P is to be seated and the seat back 100 supporting the back of the occupant P. The seat cushion 200 includes: the seat surface 210 supporting the pelvis to the thighs of the occupant P; the seat surface frame 220 forming the frame of the seat cushion 200; the seat surface spring 230 coupled to the seat surface frame 220 on the vehicle front side and supporting the seat surface 210; the lifter cross member 310 extending in the vehicle width direction on the vehicle rear side of the seat cushion 200 and lifting up and down the seat back 100 and the seat cushion 200; and the spring cross member 320 liftably provided on the vehicle lower side of the lifter cross member 310 so as to extend in the vehicle width direction, the vehicle upper side of the spring cross member 320 being coupled to the seat surface spring 230.

That is, the vehicle seat 10 lifts up and down the seat back 100 and the seat cushion 200 by the lifter cross member 310 and the spring cross member 320. The vehicle seat 10 lifts up and down the seat surface 210, which is supported from the vehicle lower side by the seat surface spring 230, by the spring cross member 320. In a state in which the seat surface 210 is located at the low position, the seat back 100 curves the spine of the occupant P in an S shape, and the seat surface 210 fixes the position of the pelvis. The vehicle seat 10 brings the posture of the occupant P into a back stretched state.

Accordingly, the vehicle seat 10 brings the posture of the occupant P into a back stretched state, so that the posture of the occupant P can be brought into a resting posture.

Further, when a collision of the vehicle V occurs, the spring cross member 320 is lifted down and accordingly the seat surface spring 230 and the seat surface 210 are lifted down, whereby the seat surface 210 immediately changes to a state of being located at the low position. The seat surface 210 is brought to a position lower than both sides of the seat cushion 200 in the vehicle width direction, so that the position of the pelvis of the occupant P is fixed.

Accordingly, since the pelvis of the occupant P is securely and immediately fixed, a load on the occupant P due to the impact at the collision can be reduced.

Thus, the occupant can take a posture for safely taking a rest, and a load on the occupant at the occurrence of the collision can be reduced.

In the vehicle seat 10 according to the embodiment, the lifter cross member 310 is provided with the depression DP for avoiding interference with the seat surface spring 230 coupled to the spring cross member 320.

That is, since the lifter cross member 310 does not interfere with the seat surface spring 230, the spring cross member 320 can lift up and down the seat surface 210, which is supported from the vehicle lower side by the seat surface spring 230, without causing an uncomfortable feeling. In a state in which the seat surface 210 is located at the low position, the seat back 100 curves the spine of the occupant P in an S shape, and the seat surface 210 fixes the position of the pelvis. Thus, the posture of the occupant P is brought into a back stretched state.

Accordingly, the posture of the occupant P is brought into a back stretched state, so that the vehicle seat 10 can bring the posture of the occupant P into a resting posture without causing an uncomfortable feeling.

Further, when a collision of the vehicle V occurs, the spring cross member 320 is lifted down without the seat surface spring 230 interfering with the lifter cross member 310, so that the seat surface 210 immediately changes to a state of being located at the low position.

Accordingly, since the pelvis of the occupant P is securely and immediately fixed, a load on the occupant P due to the impact at the collision can be reduced.

Thus, the occupant can take a posture for safely taking a rest, and a load on the occupant at the occurrence of the collision can be reduced.

The vehicle seat 10 according to the embodiment further includes the drive unit 400 that lifts up and down the lifter cross member 310 and the spring cross member 320. The drive unit 400 is provided with the lifter clutch 420 as a first clutch that moves the lifter cross member 310 and the spring clutch 430 as a second clutch that moves the spring cross member 320.

That is, when the vehicle seat 10 moves the seat surface 210 to the low position, the lifter clutch 420 is engaged with the drive clutch 412 in the drive unit 400. The spring clutch 430 gradually releases the engagement with the drive clutch 412, whereby the spring clutch 430 gently lifts down the spring cross member 320 via the spring rod 340. Then, the seat surface 210 is lifted down together with the seat surface spring 230, so that the seat surface 210 gently changes to a state of being located at the low position. In a state in which the seat surface 210 is located at the low position, the seat back 100 curves the spine of the occupant P in an S shape, and the seat surface 210 fixes the position of the pelvis. Accordingly, the vehicle seat 10 brings the posture of the occupant P into a back stretched state gently.

By bringing the posture of the occupant P into a back stretched state, the vehicle seat 10 can gently change the posture of the occupant P into a resting posture.

When a collision of the vehicle V occurs, the lifter clutch 420 is engaged with the drive clutch 412. The spring clutch 430 immediately releases the engagement with the drive clutch 412 to immediately lift down the spring cross member 320 toward the vehicle lower side via the spring rod 340, whereby the seat surface 210 immediately changes to a state of being located at the low position. The seat surface 210 is brought to a position lower than both sides of the seat cushion 200 in the vehicle width direction, so that the position of the pelvis of the occupant P is fixed.

Accordingly, when a collision of the vehicle V occurs, the pelvis of the occupant P is fixed, whereby the occupant P is prevented from sliding toward the vehicle upper side along the seat back 100 and a load on the occupant P due to the impact at the collision is reduced.

Thus, the occupant can take a posture for safely taking a rest, and a load on the occupant at the occurrence of the collision can be reduced.

### Second Embodiment

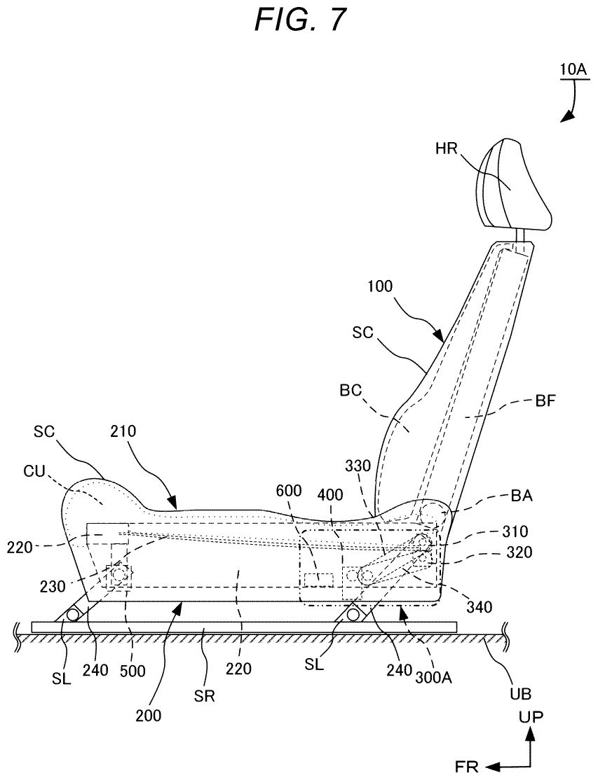

A vehicle seat 10A according to the present embodiment will be described with reference to FIG. 7 to FIG. 10.

### Vehicle Seat 10A

The vehicle seat 10A includes the seat back 100, the seat cushion 200, and a seat lifter 300A. The headrest HR is provided on the vehicle upper side of the seat back 100.

### Seat Lifter 300A

As illustrated in FIG. 7, the seat lifter 300A includes the lifter cross member 310, the spring cross member 320, the lifter rod 330, the spring rod 340, the drive unit 400, and a determination unit 600.

### Determination Unit 600

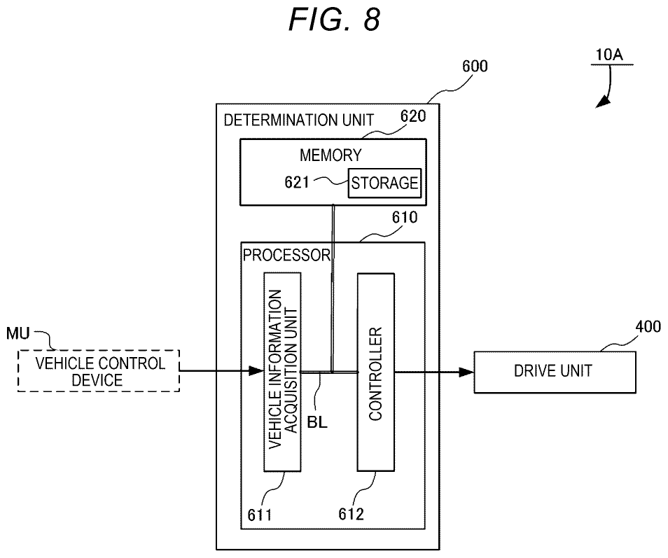

The determination unit 600 acquires information on the travel state of the vehicle V and information on the state of the seat back 100, and controls the position of the spring cross member 320 via the drive unit 400 in accordance with the acquired information. For example, the determination unit 600 is coupled to a vehicle control device MU provided at the vehicle V and acquires information on the travel state of the vehicle V and the state of the vehicle seat 10A from the vehicle control device MU. As illustrated in FIG. 8, the determination unit 600 includes a processor 610 and a memory 620.

### Processor 610

The processor 610 includes a vehicle information acquisition unit 611 and a controller 612. The vehicle information acquisition unit 611 acquires information from the vehicle control device MU. The controller 612 controls the drive unit 400 based on the information acquired by the vehicle information acquisition unit 611. The vehicle information acquisition unit 611, the controller 612, and the memory 620 are coupled to each other by a bus line BL.

The vehicle information acquisition unit 611 acquires information from the vehicle control device MU provided at the vehicle V and stores the acquired information in the memory 620.

In one example, the vehicle information acquisition unit 611 acquires, from the vehicle control device MU, for example, information on whether the vehicle V starts traveling, information on a charging time of the vehicle V, or information on whether a collision of the vehicle V occurs as the travel state of the vehicle V, and stores the information in the memory 620.

The vehicle information acquisition unit 611 acquires, from the vehicle control device MU, for example, information on whether the occupant P is seated on the vehicle seat 10A, information on the height position of the seating seat S1 in the vehicle seat 10A, or information on the backward inclination angle of the seat back 100 in the vehicle seat 10A as the state of the vehicle seat 10A, and stores the information in the memory 620.

The controller 612 controls the drive unit 400 based on the information acquired from the vehicle control device MU by the vehicle information acquisition unit 611 to lift up and down the seating seat S1.

In one example, when information indicating that the vehicle V starts traveling is acquired, the controller 612 changes the seating seat S1 to the drive position setting by moving the position of the seat surface 210 to the high position. For example, when information on the charging time of the vehicle V is acquired, the controller 612 permits the seating seat S1 to change to the rest position setting or the comfortable position setting. For example, when information indicating that a collision of the vehicle V occurs is acquired, the controller 612 changes the seating seat S1 to the low position when the seating seat S1 is located at the high position, and changes the seat surface 210 to the low position.

The memory 620 includes a read only memory (ROM), a random access memory (RAM), and the like, a control program of the processor 610 is stored in the ROM, and, for example, information on the height position of the seating seat S1 or the like is stored in a storage 621 in the RAM.

### Processing of Determination Unit 600

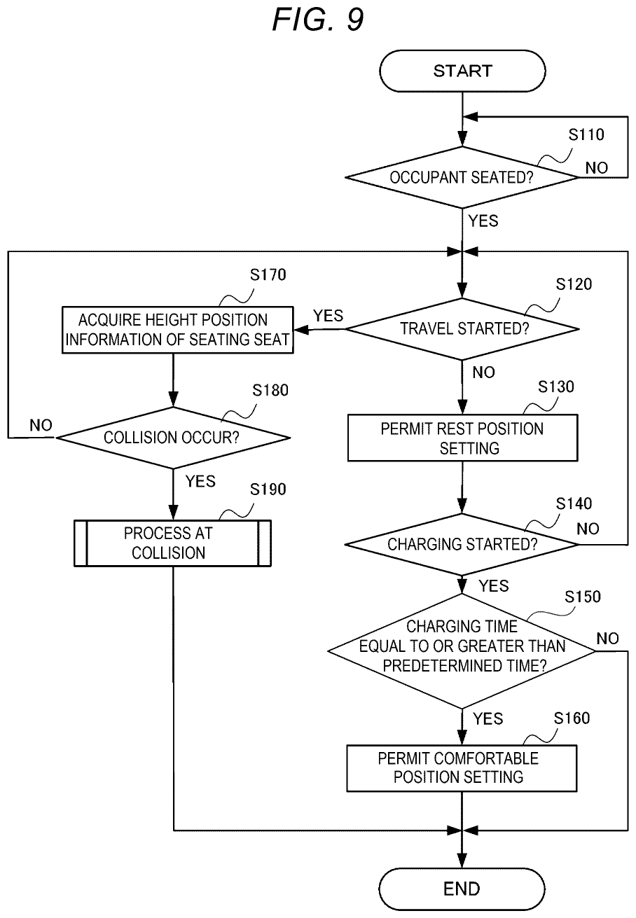

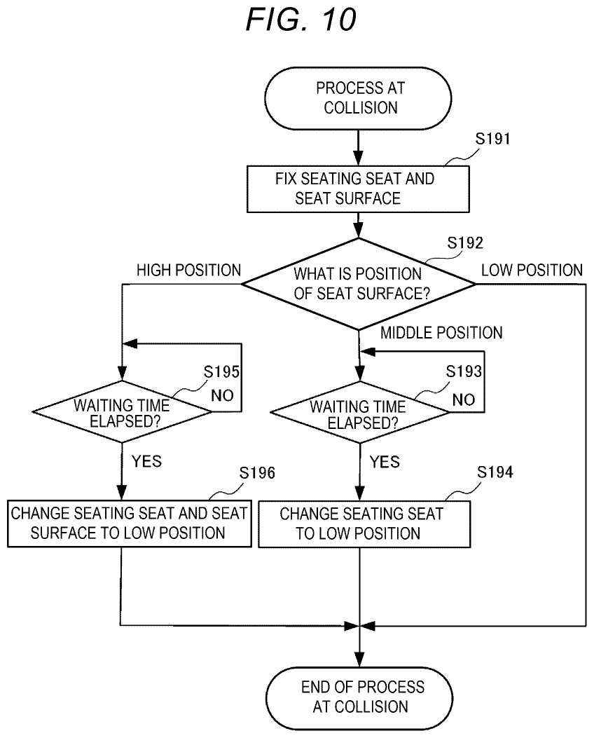

The processing of the determination unit 600 in the vehicle seat 10A according to the embodiment will be described with reference to FIG. 9 and FIG. 10.

The vehicle information acquisition unit 611 in the determination unit 600 acquires information on whether the occupant P is seated on the seating seat S1 from the vehicle control device MU and stores the information in the storage 621 of the memory 620 (step S110).

When the controller 612 acquires information indicating that the occupant P is not seated on the seating seat S1 (“NO” in step S110), the controller 612 causes the processing to transition to step S110.

On the other hand, when the controller 612 acquires information indicating that the occupant P is seated on the seating seat S1 (“YES” in step S110), the vehicle information acquisition unit 611 acquires information on whether the vehicle V starts traveling from the vehicle control device MU, and stores the information in the storage 621 (step S120).

When the controller 612 acquires information indicating that the vehicle V does not start traveling (“NO” in step S120), the controller 612 permits the rest position setting (step S130) and causes the processing to transition to step S140.

On the other hand, when the controller 612 acquires information indicating that the vehicle V starts traveling (“YES” in step S120), the vehicle information acquisition unit 611 acquires height position information of the seating seat S1 (step S170), and acquires information on whether a collision of the vehicle V occurs from the vehicle control device MU and stores the information in the storage 621 (step S180).

When the controller 612 acquires information indicating that no collision of the vehicle V occurs (“NO” in step S180), the controller 612 causes the processing to transition to step S120.

On the other hand, when the controller 612 acquires information indicating that a collision of the vehicle V occurs (“YES” in step S180), the controller 612 causes the processing to transition to a process at a collision (step S190). The details of the processing in step S190 will be described below.

After the controller 612 permits the rest position setting (step S130), the vehicle information acquisition unit 611 acquires information on whether the vehicle V is charged from the vehicle control device MU and stores the information in the storage 621 (step S140).

When the controller 612 acquires information indicating that the vehicle V is not charged (“NO” in step S140), the controller 612 causes the processing to transition to step S120.

On the other hand, when information indicating that the vehicle V is in a charged state is acquired (“YES” in step S140), the vehicle information acquisition unit 611 acquires information on the charging time of the vehicle V from the vehicle control device MU, and stores the information in the storage 621 (step S150).

When the charging time of the vehicle V is less than a predetermined charging time (“NO” in step S150), the controller 612 ends the processing. The predetermined charging time here is, for example, 5 minutes remaining until the charging is completed.

On the other hand, when the charging time of the vehicle V is equal to or greater than the predetermined charging time (“YES” in step S150), the controller 612 permits the comfortable position setting by allowing the seat back 100 to be inclined rearward to or in excess of the predetermined angle PA (step S160), and ends the processing.

### Process at Collision of Vehicle V

The process at a collision of the vehicle V will be described with reference to FIG. 10.

In the process at a collision of the vehicle V, the controller 612 fixes the seating seat S1 and the seat surface 210 (step S191), and acquires the position of the seat surface 210 (step S192).

When the seat surface 210 is located at a low position (“low position” in step S192), the controller 612 ends the process at a collision of the vehicle V.

When the seat surface 210 is located at a middle position (“middle position” in step S192), the controller 612 determines whether a predetermined waiting time has elapsed (step S193). When the predetermined waiting time has not elapsed (“NO” in step S193), the controller 612 causes the processing to transition to step S193. On the other hand, when the predetermined waiting time has elapsed “YES” in step S193), the controller 612 controls the position of the lifter cross member 310 to change the seating seat S1 to the low position (step S194), and ends the process at a collision of the vehicle V. The predetermined waiting time here is, for example, a time from the occurrence of a collision of the vehicle V to the expansion of an airbag.

When the seat surface 210 is located at a high position (“high position” in step S192), the controller 612 determines whether the predetermined waiting time has elapsed (step S195). When the predetermined waiting time has not elapsed (“NO” in step S195), the controller 612 causes the processing to transition to step S195. On the other hand, when the predetermined waiting time has elapsed (“YES” in step S195), the controller 612 controls the position of the lifter cross member 310 to change the seating seat S1 to the low position and controls the position of the spring cross member 320 to change the seat surface 210 to the low position (step S196), and ends the process at a collision of the vehicle V.

### Effects

As described above, the vehicle seat 10A according to the embodiment further includes the determination unit 600 that controls the drive unit 400. The determination unit 600 acquires information on the travel state of the vehicle V and information on the state of the seat back 100, and controls the position of the spring cross member 320 via the drive unit 400 in accordance with the acquired information.

That is, when the controller 612 in the determination unit 600 acquires information indicating that the vehicle V starts traveling, the controller 612 moves the position of the spring cross member 320 to the high position to move the position of the seat surface 210 to the high position, thereby changing the seating seat S1 to the drive position setting. When information on the charging time of the vehicle V is acquired, the controller 612 permits the seating seat S1 to change to the rest position setting or the comfortable position setting.

Thus, the vehicle seat 10A can permit the drive position setting, the rest position setting, or the comfortable position setting in accordance with the travel state of the vehicle V and the state of the seat back 100.

When information indicating that a collision of the vehicle V occurs, the controller 612 changes the position of the spring cross member 320 to the low position.

Accordingly, upon acquiring information indicating that a collision of the vehicle V occurs, the vehicle seat 10A can change the position of the seat surface 210 to the low position, thereby fixing the pelvis of the occupant P and reducing a load on the occupant P due to the impact at the collision.

Thus, the occupant can take a posture for safely taking a rest, and a load on the occupant at the occurrence of the collision can be reduced.

In the vehicle seat 10A according to the embodiment, when a collision of the vehicle V occurs, the determination unit 600 controls the position of the spring cross member 320 in accordance with a height position at which the lifter cross member 310 is set.

That is, when a collision of the vehicle V occurs, the controller 612 changes, after the predetermined waiting time has elapsed, the positions of the lifter cross member 310 and the spring cross member 320 to the low positions based on information on the height position of the seating seat S1 and information on the height position of the seat surface 210.

Accordingly, when a collision of the vehicle V occurs, the vehicle seat 10A can change the position of the seat surface 210 to the low position, thereby fixing the pelvis of the occupant P and reducing a load on the occupant P due to the impact at the collision.

Thus, the occupant can take a posture for safely taking a rest, and a load on the occupant at the occurrence of the collision can be reduced.

It is noted that the vehicle seat 10A of the disclosure can be achieved by recording the processing of the processor 610 in a recording medium which is readable by a computer system and by causing the processor 610 to read and execute a program recorded in the recording medium. The computer system here includes an OS and hardware such as a peripheral device.

The “computer system” includes a homepage providing environment (or display environment) when a world wide web (WWW) system is used. The above-described program may be transmitted from a computer system in which the program is stored in a storage device or the like to another computer system via a transmission medium or by a transmitted wave in the transmission medium. Here, the “transmission medium” transmitting the program refers to a medium having a function of transmitting information, such as a network (communication network) including the Internet, or a communication line (communication wire) including a phone line.

The above-described program may be a program for implementing a part of the functions described above. Further, the above-described program may be a program that can implement the above-described functions in combination with a program already recorded in the computer system, that is, a so-called difference file (difference program).

The embodiments of the present disclosure have been described above in detail with reference to the drawings, but specific configurations are not limited to the embodiments, and designs and the like within the scope not departing from the gist of the disclosure are also included.

1. A vehicle seat configured to be applied to a vehicle, the vehicle seat comprising:
a seat cushion on which an occupant of the vehicle is to be seated; and
a seat back configured to support a back of the occupant,
the seat cushion comprising:
a seat surface configured to support a pelvis to thighs of the occupant;
a seat surface frame forming a frame of the seat cushion;
a seat surface spring coupled to the seat surface frame on a vehicle front side, the seat surface spring supporting the seat surface;
a lifter cross member extending in a vehicle width direction on a vehicle rear side of the seat cushion, the lifter cross member being configured to lift up and down the seat back and the seat cushion; and
a spring cross member liftably provided on a vehicle lower side of the lifter cross member, the spring cross member extending in the vehicle width direction, the spring cross member being coupled to the seat surface spring.

2. The vehicle seat according to claim 1, wherein the lifter cross member is provided with a depression that avoids interference with the seat surface spring coupled to the spring cross member.

3. The vehicle seat according to claim 1, further comprising:
a drive unit configured to lift up and down the lifter cross member and the spring cross member,
wherein the drive unit is provided with a first clutch configured to move the lifter cross member and a second clutch configured to move the spring cross member.

4. The vehicle seat according to claim 2, further comprising:
a drive unit configured to lift up and down the lifter cross member and the spring cross member,
wherein the drive unit is provided with a first clutch configured to move the lifter cross member and a second clutch configured to move the spring cross member.

5. The vehicle seat according to claim 3, further comprising:
a determination unit comprising a processor and a memory, the determination unit being configured to control the drive unit,
wherein the determination unit is configured to acquire information on a travel state of the vehicle and information on a state of the seat back, and control, via the drive unit, a position of the spring cross member in accordance with the information acquired.

6. The vehicle seat according to claim 4, further comprising:
a determination unit comprising a processor and a memory, the determination unit being configured to control the drive unit,
wherein the determination unit is configured to acquire information on a travel state of the vehicle and information on a state of the seat back, and control, via the drive unit, a position of the spring cross member in accordance with the information acquired.

7. The vehicle seat according to claim 5, wherein the determination unit is configured to, when a collision of the vehicle occurs, control a height position of the spring cross member in accordance with a height position at which the lifter cross member is set.

8. The vehicle seat according to claim 6, wherein the determination unit is configured to, when a collision of the vehicle occurs, control a height position of the spring cross member in accordance with a height position at which the lifter cross member is set.
